(19) United States
(12) Patent Application Publication
(10) Pub. No.: US 2020/0041177 A1
(43) Pub. Date: Feb. 6, 2020

(54) THERMOMAGNETIC CYCLE DEVICE

(71) Applicant: DENSO CORPORATION, Kariya-city (JP)

(72) Inventor: Shunji Itou, Kariya-city (JP)

(21) Appl. No.: 16/521,775

(22) Filed: Jul. 25, 2019

(30) Foreign Application Priority Data
Aug. 2, 2018 (JP) 2018-146111

(51) Int. Cl. F25B 21/00; H01F 7/02

(52) U.S. Cl. CPC F25B 21/00; F25B 2321/0023; F25B 2321/0022; H01F 7/02

(57) ABSTRACT

A thermomagnetic cycle device has a plurality of element beds including a magneto-caloric effect element that demonstrates a magneto-caloric effect. A magnetic field modulation device modulates a magnetic field applied to the magneto-caloric effect element. A heat transport device generates a reciprocating flow of a heat transport medium which performs heat-exchange with the magneto-caloric effect element. A variable flow path mechanism activates a part of the plurality of element beds and deactivates a remaining part. A controller determines an active bed number according to a required capacity. The active element bed is arranged to suppress torque fluctuations.

### CROSS REFERENCE TO RELATED APPLICATION

The present disclosure is based on Japanese Patent Application No. 2018-146111 filed on Aug. 2, 2018, the whole contents of which are incorporated herein by reference.

### FIELD

Disclosure in this specification relates to a thermomagnetic cycle device.

### BACKGROUND

A thermomagnetic cycle device or a magneto-thermal cycle device utilizes the magneto-thermal properties of a magneto-caloric element. These devices include a magnetic field fluctuation device that periodically changes a magnetic field, and a heat transport device that creates a reciprocating flow of a heat transport medium. There is a need for further improvements in thermomagnetic cycle devices.

### SUMMARY

In one aspect of disclosure, a thermomagnetic cycle device, comprises: a plurality of element beds providing a magneto-caloric effect element demonstrating a magneto-caloric effect, and a flow path which allow a flow of a heat transport medium to perform heat-exchange with the magneto-caloric effect element; a variable flow passage mechanism which changes a structure of the flow path in the plurality of element beds; and a controller which controls the variable flow path mechanism so as to suppress power consumption while achieving a required capacity.

The thermomagnetic cycle device includes a variable flow path mechanism that changes the flow path provided by the plurality of element beds. The flow path is controlled to suppress power consumption while achieving the required capacity. Thus, when there are a plurality of flow path options which can realize the required capacity, a flow path that suppresses power consumption is selected. This provides the thermomagnetic cycle device which suppresses power consumption while satisfying the required capacity.

In one other aspect of disclosure, a thermomagnetic cycle device, comprises: a plurality of element beds including a magneto-caloric effect element demonstrating a magneto-caloric effect; a magnetic field modulation device which modulates the magnetic field applied to the magneto-caloric effect element; a heat transport device which generates a reciprocating flow of a heat transport medium which performs heat-exchange with the magneto-caloric effect element; and a variable flow path mechanism which activates a part of the plurality of element beds as at least one active bed and deactivates a part of the plurality of element beds as at least one inactive bed.

The thermomagnetic cycle device activates a part of the plurality of element beds and deactivates a part of the plurality of element beds. This allows for adjustment of the capacity.

The disclosed aspects in this specification adopt different technical solutions from each other in order to achieve their respective objectives. Reference numerals in parentheses described in claims and this section exemplarily show corresponding relationships with parts of embodiments to be described later and are not intended to limit technical scopes. The objects, features, and advantages disclosed in this specification will become apparent by referring to following detailed descriptions and accompanying drawings.

### BRIEF DESCRIPTION OF THE DRAWINGS

FIG. 1 is a block diagram of a thermal apparatus according to a first embodiment.

FIG. 2 is a cross-sectional view showing an element bed.

FIG. 3 is a flowchart showing control processing.

FIG. 4 is a graph showing thermal capacity Q and efficiency COP.

FIG. 5 is a table showing an example of active number(s).

FIG. 6 is a graph showing thermal capacity Q and efficiency COP.

FIG. 7 is a cross-sectional view showing an arrangement of active bed(s).

FIG. 8 is a waveform diagram showing torque fluctuation.

FIG. 9 is a cross-sectional view showing an arrangement of active bed(s).

FIG. 10 is a cross-sectional view showing an element bed of a second embodiment.

FIG. 11 is a graph showing thermal capacity Q and efficiency COP.

FIG. 12 is a cross-sectional view showing an element bed of a third embodiment.

FIG. 13 is a perspective view showing a relationship between an element bed and a flow path.

FIG. 14 is a cross-sectional view showing an element bed of a fourth embodiment.

FIG. 15 is a cross-sectional view showing an element bed of a fifth embodiment.

FIG. 16 is a cross-sectional view showing an element bed of a sixth embodiment.

### EMBODIMENT

Hereinafter, a plurality of embodiments will be described with reference to the drawings. In some embodiments, parts that are functionally and/or structurally corresponding and/or associated are given the same reference numerals, or reference numerals with different hundred digit or more digits. For corresponding parts and/or associated parts, reference can be made to the description of other embodiments.

### First Embodiment

<System>

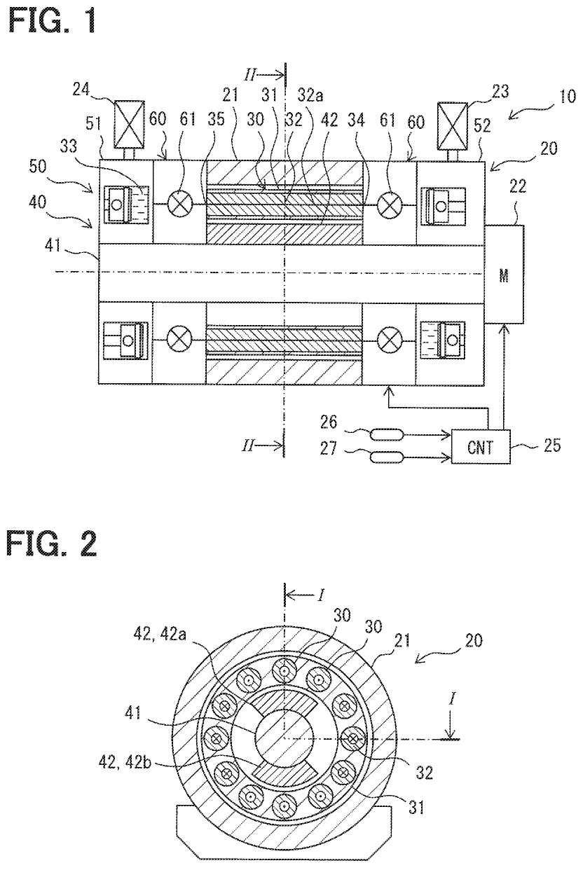

In FIG. 1, this embodiment provides an air conditioner 10 which is an example of a thermal device. The air conditioner 10 is mounted on a vehicle and adjusts the temperature of the passenger compartment of the vehicle. The term vehicle includes movable body such as vehicles, ships, and aircrafts, and immovable body such as amusement equipment and entertainment equipment. The air conditioner 10 is also called a heating device or a ventilation device. The air conditioner 10 includes a magneto-caloric heat pump device 20. The magneto-caloric heat pump device 20 is also referred to as a MHP (Magneto-caloric effect Heat Pump) device 20. The MHP device 20 provides a magneto-thermal cycle device.

In this specification the term “heat pump device” is used in a broad sense. That is, the term “heat pump device” includes both a device utilizing cold energy obtained by the heat pump device and a device utilizing hot energy obtained by the heat pump device. Devices that utilize cold energy may also be referred to as refrigeration cycle devices. Hence, in this specification the term “heat pump device” is used as a concept encompassing a refrigeration cycle device.

The MHP device 20 has a cylindrical housing 21. The MHP device 20 includes a plurality of parts inside or outside the housing 21. The MHP device 20 has a power source 22. The power source 22 rotates a rotary shaft 41. The power source 22 is an electric motor. The power source 22 may be an internal combustion engine.

The MHP device 20 has a plurality of element beds 30, a magnetic field modulation device (MGFM) 40, and a heat transfer device (THFM) 50. The element beds 30 have a container 31, a magneto-caloric effect element 32, and a heat transport medium 33. The magneto-caloric effect element 32 is also referred to as a MCE (Magneto-Caloric Effect) element 32. The MHP device 20 utilizes the magneto-caloric effect of the MCE element 32. The container 31 accommodates the MCE element 32 and the heat transport medium 33. The MCE element 32 has a passage 32a which allows the heat transport medium 33 to flow in the element bed 30 so as to perform heat-exchange with the MCE element 32. The passage 32a is provided by a gap between the granular MCE elements 32, a groove provided in the plate-like MCE element 32, a gap between the small piece-like MCE elements 32, and the like.

The magnetic field modulation device 40 and the heat transport device 50 function the MCE element 32 and the heat transport medium 33 as an AMR (Active Magnetic Refrigeration) cycle. The magnetic field modulation device 40 and the heat transport device 50 synchronously generate the change of the magnetic field and the reciprocating flow of the heat transport medium 33. The magnetic field modulation device 40 and the heat transport device 50 can be provided with, e.g., a motor as a power source. The MHP device 20 may include a phase adjuster that adjusts phase between change in the magnetic field and change in the reciprocating flow of the heat transport medium 33 with respect to the MCE element 32.

<Magneto-Caloric Effect Element>

The MCE element 32 generates a cold end 34 and a hot end 35 by functioning as the AMR cycle. The cold end 34 may be referred to as a cold end. The hot end 35 may be referred to as a high temperature end. The cold end 34 and the hot end 35 appear at both ends of the element bed 30. The MHP device 20 functions as the AMR cycle so that the heat transport medium 33 at the cold end 34 has a predetermined low temperature TL. The MHP device 20 functions as the AMR cycle so that the heat transport medium 33 at the hot end 35 has a predetermined high temperature TH.

The MCE element 32 creates heat generation and heat absorption according to strength of the external magnetic field. The MCE element 32 generates heat by applying the external magnetic field, and absorbs heat by removing the external magnetic field. When the electron spins become aligned in the magnetic field direction by the application of the external magnetic field, the MCE element 32 demonstrates both a decreasing of magnetic entropy and an increasing of a temperature by releasing heat. Further, when the electron spins become random by the removal of the external magnetic field, the NICE element 32 demonstrates both an increasing of the magnetic entropy and a decreasing of a temperature by absorbing heat.

The MCE element 32 contains a material which demonstrates a magneto-caloric effect. The MCE element 32 is a collection of particles of material. The MCE element 32 is provided by an adhesive solidified by a binder resin or a sintered body obtained by sintering particles of a material. The MCE element 32 is made of a magnetic material that demonstrates a high magneto-caloric effect in a normal temperature range. For example, gadolinium-based materials or lanthanum-iron-silicon compounds can be used. Also, mixtures of manganese, iron, phosphorus and germanium can be used.

The MCE element 32 has a plurality of partial elements connected in cascade. One of the plurality of partial elements is a cold end element which is an end element located at the cold end 34. Another one of the plurality of partial elements is a hot end element which is an end element located at the hot end 35. The plurality of partial elements have different materials, composition ratios, and the like. The plurality of partial elements are arranged in series in a longitudinal direction of the MCE element 32, that is, are arranged in the flow direction of the heat transport medium 33. A temperature zone in which the partial element demonstrates a high magneto-caloric effect is called a high efficiency temperature zone. The plurality of partial elements are arranged in series so that high efficiency temperature zones are continuously aligned between the cold end 34 and the hot end 35. The plurality of high efficiency temperature zones of the plurality of partial elements are different from one another. The plurality of high efficiency temperature zones are distributed so as to cover the range of a predetermined load temperature difference. The plurality of partial elements are connected in series such that a plurality of high efficiency temperature zones are continuous.

The materials constituting each of the plurality of partial elements have different Curie temperatures. The Curie temperature is a change point between the paramagnetic state and the ferromagnetic state. The plurality of cascaded partial elements are arranged in series so that their Curie temperatures monotonously increase. It is to be noted that auxiliary partial elements of intermediate Curie temperature may be redundantly arranged across two main partial elements.

The plurality of partial elements demonstrate high magneto-caloric effect (ΔS(J/kgK):Delta-S) in different temperature zones. A portion close to the cold end 34 has a material composition that demonstrates a high magneto-caloric effect at a vicinity of a temperature appearing at the cold end 34 in steady state operating condition. A portion close to the hot end 35 has a material composition that demonstrates a high magneto-caloric effect at a vicinity of a temperature appearing at the hot end 35 in the steady state operating condition. A portion close to a middle temperature part has a material composition that demonstrates a high magneto-caloric effect at a vicinity of a temperature appearing in the middle temperature part in the steady state operating condition.

The MCE element 32 performs heat-exchange with the heat transport medium 33. Flow direction of the heat transport medium 33 extends along the longitudinal direction LD of the MCE element 32. The heat transport medium 33 can be provided by a fluid such as antifreeze, water, oil, gas or the like. The heat transport medium 33 is also referred to as a working fluid.

<Magnetic Field Modulation Device>

The magnetic field modulation device 40 applies an external magnetic field to the MCE element 32 and changes strength of the magnetic field applied to the MCE element 32 in a strong condition and a weak condition. The magnetic field modulation device 40 periodically switches between a magnetization state in which the MCE element 32 is in a strong magnetic field and a demagnetization state in which the MCE element 32 is in a weak magnetic field or a zero magnetic field. The magnetic field modulation device 40 modulates the external magnetic field so as to periodically repeat a magnetization period in which the MCE element 32 is placed in a strong external magnetic field and a demagnetization period in which the MCE element 32 is placed in an external magnetic field weaker than the magnetization period. The magnetic field modulation device 40 comprises a magnetic source, such as a permanent magnet or an electromagnet, for generating an external magnetic field.

The magnetic field modulation device 40 is provided by, for example, a permanent magnet 42 mounted on the rotary shaft 41 so as to periodically change the magnetic field applied to the element bed 30. In the illustrated example, the permanent magnet 42 is disposed inside the element bed 30. The permanent magnet 42 may sandwich the element bed 30. For example, a permanent magnet or a yoke can be disposed radially outside the element bed 30. Alternatively, the element bed 30 may be moved periodically by fixing a permanent magnet. The magnetic field modulation device 40 can be provided by a mechanism that relatively changes the distance between the element bed 30 and the magnetic source in order to periodically change the distance between the element bed 30 and the magnetic source. The magnetic field modulation device 40 causes, for example, relative movement between the MCE element 32 and the magnetic field source. The magnetic field modulation device 40 allows magnetic flux to pass, for example, in the thickness direction (radial direction) of the element bed 30.

<Heat Transport Device>

The heat transport device 50 causes relative movement of the heat transport medium 33 with respect to the MCE element 32. The heat transport device 50 includes a fluid device for allowing flow of a heat transport medium 33 for transporting the heat released or absorbed by the MCE element 32. In the illustrated example, as the fluid devices, reciprocating displacement pumps 51 and 52 that operate complementarily on the left and right are illustrated. The heat transport device 50 is a device for flowing the heat transport medium 33 which performs heat-exchange with the MCE element 32 along the MCE element 32. The heat transport device 50 creates relative displacement between the MCE element 32 and the heat transport medium 33 such that the cold end 34 and the hot end 35 are generated by the MCE element 32. This relative displacement is provided by the reciprocal flow of the heat transport medium 33 relative to the MCE element 32. The heat transport device 50 is provided by the movement of the MCE element 32 or the flow of the heat transport medium 33.

The descriptions of the patent documents JP2012-237545A, JP2012-47385A, and JP2016-109412A are introduced by reference as descriptions of the element bed 30, the magnetic field modulation device 40, and the heat transport device 50.

<Variable Flow Path Mechanism>

The MHP device 20 includes a variable flow path mechanism 60. The variable flow passage mechanism 60 is also referred to as a variable flow passage mechanism. The variable flow path mechanism 60 causes a portion of the plurality of element beds 30 to effectively function with respect to the magneto-caloric effect, and a remaining portion of the plurality of element beds 30 to invalidate with respect to the magneto-caloric effect The variable flow path mechanism 60 provides a state in which all of the plurality of element beds 30 function effectively with respect to the magneto-caloric effect. The variable flow path mechanism 60 provides a state in which all of the plurality of element beds 30 are invalidated with respect to the magneto-caloric effect. A state in which the element bed 30 functions effectively is also referred to as an active state. An element bed 30 that is activated about the magneto-caloric effect is referred to as an active bed. A state in which the element bed 30 is deactivated is also referred to as an inactive state. An element bed 30 that is deactivated about the magneto-caloric effect is referred to as an inactive bed.

One element bed 30 is disposed between the cold end 34 and the hot end 35. The plurality of element beds 30 are arranged in parallel between the cold end 34 and the hot end 35. The variable flow path mechanism 60 generates at least one active bed and at least one inactive bed from the plurality of element beds 30. As a result, the variable flow path mechanism 60 adjusts the number of active bed(s) and the number of inactive bed(s) among the plurality of element beds 30 arranged in parallel between the cold end 34 and the hot end 35. The variable flow path mechanism 60 varies the number of active bed and the number of inactive bed in a stepwise manner. The number of active bed(s) may be referred to as an active bed number N. Since the element bed 30 is also a flow path for the heat transport medium 33, the variable flow path mechanism 60 changes the number of path between the cold end 34 and the hot end 35. The variable flow path mechanism 60 generates an active flow path and an inactive flow path in the flow path between the cold end 34 and the hot end 35. The variable flow path mechanism 60 is also a variable flow passage mechanism that changes the structure of the flow passage between the cold end 34 and the hot end 35.

The variable flow path mechanism 60 is disposed in the flow passage of the heat transport medium 33 so as to turn-on/turn-off (permit/block) the flow of the heat transport medium 33 in one element bed 30. In the illustrated example, the variable flow path mechanism 60 is disposed at both ends of one element bed 30. The variable flow passage mechanism 60 includes an on-off valve 61. The on-off valve 61 controls the flow of the heat transport medium 33 in the plurality of element beds 30. The open/close function of the on-off valve 61 may be able to control the flow of the heat transport medium 33 so as to substantially turn on/off the magneto-caloric effect of the element bed 30. In the illustrated example, on-off valves 61 and 61 are disposed on both ends of the element bed 30 as a typical example.

<External System>

The MHP device 20 has external systems 23 and 24. At least one of the external systems 23 and 24 provides air heating or air cooling as the air conditioner 10. In this embodiment, the external system 23 cools the air with the low temperature obtained from the cold end 34. The external system 23 is also referred to as a low temperature system including a heat exchanger. The external system 24 heats the air with the high temperature obtained from the hot end 35. The external system 24 is also referred to as a high temperature system including a heat exchanger.

<Control Device>

The air conditioner 10 includes a control device (CNT) 25. The control device 25 controls equipment of the air conditioner 10 such as the magnetic field modulation device 40 and the heat transport device 50. The controller 25 controls the variable flow path mechanism 60. The control device 25 is an electronic control unit. The control device 25 has at least one arithmetic processing unit (CPU) and at least one memory device as a storage medium for storing programs and data. The control device 25 is provided by a microcomputer provided with a computer readable storage medium. The storage medium is a non-transitional tangible storage medium that temporarily stores a computer-readable program. The storage medium may be provided by a semiconductor memory, a magnetic disk, or the like. The controller 25 may be provided by one computer or a set of computer resources linked by a data communication device. The program is executed by the controller 25 to cause the controller 25 to function as the device described in this specification and to function the controller 25 to execute the method described in this specification.

The means and/or function provided by the control device 25 can be provided by software stored in a tangible memory device and a computer that executes the software, only software, only hardware, or a combination thereof. For example, the controller 25 can be provided by a logic called if-then-else type or a neural network tuned by machine learning. Alternatively, for example, where the controller 25 is provided by an electronic circuit that is hardware, it can be provided by a digital circuit or analog circuit that includes multiple logic circuits.

The air conditioner 10 comprises a plurality of sensors for detecting environmental conditions. In the drawing, an indoor temperature sensor 26 for detecting the indoor temperature and an outdoor temperature sensor 27 for detecting the outdoor temperature are illustrated. The controller 25 obtains the required capacity and the environmental conditions from the plurality of sensors. The control device 25 controls a plurality of control targets of the air conditioner 10. Here, the power source 22 and the variable flow path mechanism 60 are controlled. Specifically, the power source 22 is controlled in rotational speed to adjust the flow rate in one reciprocating flow. The number of revolutions changes the frequency of the reciprocating flow and the flow rate per time. The variable flow path mechanism 60 is controlled to control the number of active bed(s) and the number of inactive bed(s). Furthermore, the variable flow path mechanism 60 is controlled to control a position of the active bed(s) in the circumferential direction. The position of the active bed(s) is controlled to suppress the fluctuation of the torque for driving the MHP device 20. The control device 25 included in the control system, the sensor as a signal source and the control object provide various elements. At least some of these elements can be referred to as blocks for performing the function. In another aspect, at least some of those elements can be referred to as modules or sections that are interpreted as a configuration. Furthermore, the elements contained in the control system can also be referred to as means for realizing its function only on a deliberate basis.

FIG. 2 shows a cross section taken along line II-II of FIG. 1. FIG. 1 shows a cross section taken along line I-I of FIG. 2. The axial and circumferential directions can be understood from FIGS. 1 and 2. The axial direction is a direction in which the central axis of the rotary shaft 41 extends. The circumferential direction is the rotation direction of the rotary shaft 41.

In FIG. 2, the plurality of element beds 30 are arranged along the circumferential direction. Each of the plurality of element beds 30 extends in the axial direction. The plurality of element beds 30 are arranged in parallel to one another. In this embodiment, twelve element beds 30 are illustrated as an example. The number of element beds 30 may be less or more than twelve.

The permanent magnets 42 of the magnetic field modulation device 40 are arranged to alternately provide a magnetization range and a demagnetization range in the rotational direction. The partial cylindrical permanent magnets 42a and 42b occupy a range of ¼ circle. The two permanent magnets 42a and 42b are disposed on the opposite side of the rotary shaft 41. In this embodiment, a plurality of permanent magnets 42 provide rotating magnetic fields of multiple poles. The two permanent magnets 42a and 42b provide a rotating magnetic field of two poles.

The heat transport device 50 causes a reciprocal flow of the heat transport medium 33 which is synchronous with an alternate change of the magnetization range and the demagnetization range by the magnetic field modulation device 40 when all the element beds 30 are activated. In the case of the illustrated moment, a flow of heat transport medium 33 is provided which is directed in the direction of the arrow indicated by the arrow head symbol (·) and the arrow tail symbol (X). When the rotary shaft 41 rotates 90 degrees, a flow of the heat transport medium 33 opposite to the illustrated direction is supplied.

<Control Processing/Algorithm>

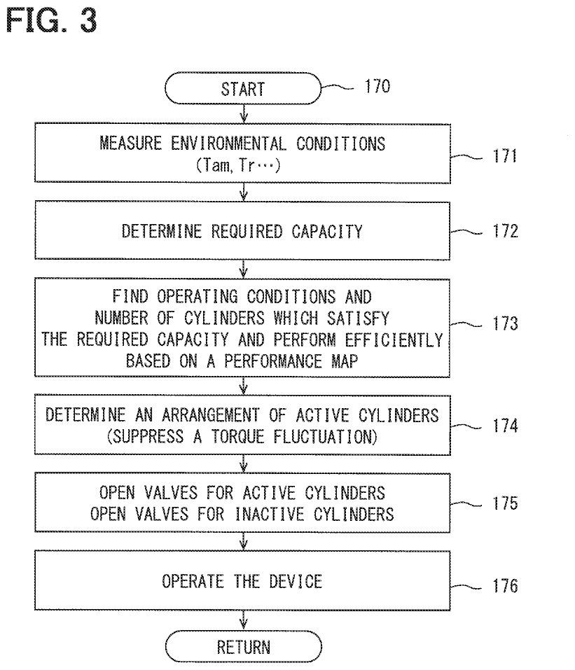

FIG. 3 shows a part of a control process 170 that the controller 25 executes. In step 171, environmental conditions are measured. The controller 25 acquires environmental conditions from the plurality of sensors 26 and 27 and the plurality of setting devices. The environmental conditions include, an outdoor air temperature Tam, an indoor air temperature Tr, a set temperature as a target, etc. Furthermore, the environmental conditions may include data indicating natural environment such as solar radiation, elevation, humidity and the like. In step 172, a required capacity is determined. The required capacity means a thermal capacity Q of the MHP device 20 necessary to realize a target air conditioning by the air conditioner 10. This thermal capacity Q indicates both cooling capacity and heating capacity. The required capacity is indicated, e.g., in units of kilowatts (kW). The required capacity may be set by the setting device. The required capacity may be set based on detection values of the plurality of sensors. In this embodiment, the required capacity is set by a user-operable setting device.

In step 173, from the performance map, a combination of operating conditions and a number N of active bed(s) is determined. The combination meets the required capacity and has good efficiency COP. The number N of active bed(s) means, conversely, a number of inactive bed(s). Here, the efficiency COP can be defined as COP=thermal capacity/input power=freezing capacity/(magnetic field fluctuation work+pump work).

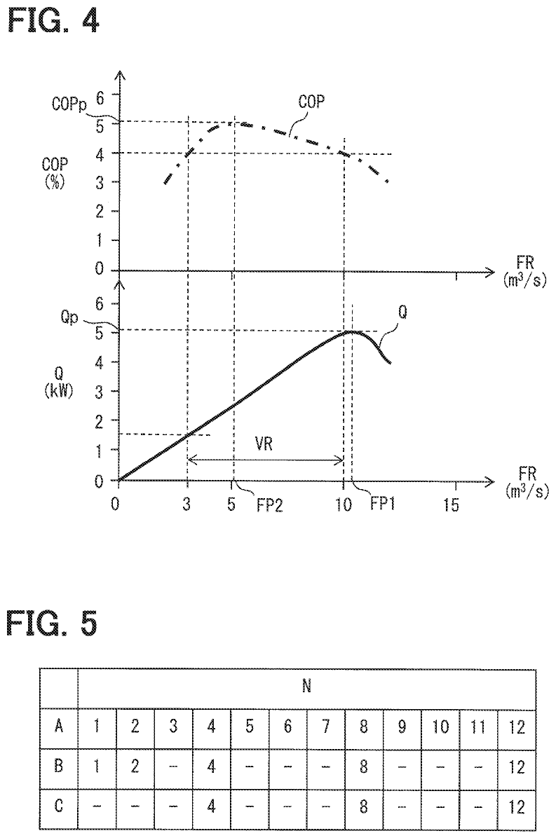

FIG. 4 shows an example of a performance curve. The performance curve is predetermined. The performance curve shows a relationship between the operating condition of one element bed 30 (cylinder) and the capacity Q (kW). The performance curve shows the relationship between the operating condition of one element bed 30 (cylinder) and the efficiency COP (%). Here, the operating condition is the frequency f (Hz) of the reciprocal flow of the heat transport medium 33, in other words, the flow rate FR (m\hat{ }3/s) per unit time. The numerical values of the flow rate FR, the capacity Q, and the efficiency COP indicate only the number of scales. The numerical values are not specific values, e.g., 5 kW.

The capacity Q has a peak capacity Qp at a predetermined peak flow rate FP1 (frequency f), The line of the capacity Q shows the characteristic that the capacity Q increases as the flow rate FR increases toward the peak flow rate FP1. The line of the capacity Q shows the characteristic of rapidly decreasing when the flow rate FR becomes excessive. A gradient of the capacity Q in the range below the peak flow rate FP1 is smaller than a gradient of the capacity Q above the peak flow rate FP1. Therefore, the capacity Q can be adjusted by changing the flow rate FR (frequency f) in the adjustment range VR equal to or less than the peak flow rate FP1.

The efficiency COP has a peak efficiency COPp at a predetermined peak flow rate FP2 (frequency f), The line of efficiency COP shows relatively smoothly changing characteristics in the range before and after the peak flow rate FP2. Thus, the capacity Q can be adjusted in the adjustment range VR including the peak flow rate FP2.

The peak flow rate FP2 is lower than the peak flow rate FP1. Moreover, a gradient of the efficiency COP is relatively gentle, and an amount of change in the efficiency COP is small. For example, in the adjustment range VR, the capacity Q changes to three or more scales, but the efficiency COP changes only one scale. Therefore, if the operating condition is changed in the adjustment range VR in order to adjust the capacity Q, a change amount in the efficiency COP is even small. Thus, the performance curve is desirable when the peak flow rate FP1 of the capacity Q is on a higher flow rate side than the peak flow rate FP2 of the efficiency COP. In other words, it is desirable that the peak flow rate FP1 is larger than the peak flow rate FP2. In this embodiment, the operating conditions are adjusted to obtain the highest possible efficiency while satisfying the required capacity.

FIG. 5 shows a map for setting the number N of active bed(s). When there are 12 element beds 30 (cylinders) as in the illustrated embodiment, various switching modes can be adopted. In one switching mode A, the active bed number N is changed one by one. When the maximum output of one element bed 30 is 1, it is possible to adjust the capacity in stages of 1 to 12 by simply changing the active bed number. Furthermore, by changing the operating conditions, capacity adjustment of 1 or less is possible. In the other switching mode B, the active bed number N is changed to 1, 2, 4, 8, and 12, Here again, it is possible to adjust the capacity in stages of 1 to 12 by adjusting both the active bed number and the operating conditions. In a still other switching mode C, the active bed number N is changed to 4, 8, and 12. Here again, it is possible to adjust the capacity in stages of 1 to 12 by adjusting both the active bed number and the operating conditions. The active bed number is determined such that the required capacity can be met at an operating condition as close as possible to the peak flow rate FP2.

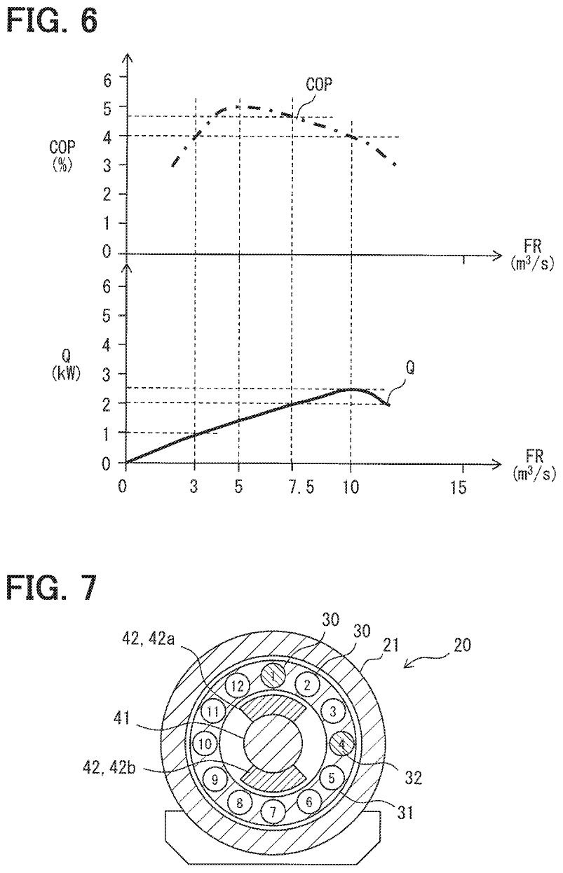

FIG. 6 shows a case where the maximum capacity of one element bed 30 (cylinder) is 2.5 (kW). It is assumed that the MHP device 20 comprises four element beds 30 (cylinders). In this case, if the capacity Q=10 (kW) is required, four beds are activated and operated at the operating condition FR=10. As a result, it can obtain the capacity Q=10=2.5×4 and the efficiency COP=4 approximately. If the capacity Q=4 (kW) is required, four beds are activated and operated at the operating condition FR=3. As a result, it can obtain the capacity Q=4=1.0×4 and the efficiency COP=4 approximately. However, if the capacity Q=4 (kW) is required, and if two beds can be activated and be operated at the operating condition FR=7.5, the device can realize the capacity Q=4=2.0×2 under the efficiency COP=4.6 approximately.

Returning to FIG. 3, in step 173, a combination of operating conditions and the number of active bed(s) are determined. Here, the maximum capacity Qmax which can be demonstrated by the MHP device 20 is determined from the configuration of the element bed 30 and the number of beds. The minimum capacity Qmin which can be demonstrated by the MHP device 20 is determined from the configuration of the element bed 30 and limit values of the operating conditions. When the required capacity is between the minimum capacity Qmin and the maximum capacity Qmax, the MHP device 20 may provide a plurality of combinations of active bed number N and operating conditions, e.g., flow rate FR (frequency f.) The combinations satisfy the required capacity. In this embodiment, the control device 25 selects a combination having the highest efficiency COP from among a plurality of combinations. The control device 25 provides the operating condition and the number of active bed(s) realize the selected combination. The controller 25 controls the power source 22, the magnetic field modulation device 40, the heat transport device 50, and the variable flow path mechanism 60 so as to realize the selected combination.

The controller 25 has a function of controlling the active bed number N by the variable flow path mechanism 60. The controller 25 has a function of controlling the capacity Q demonstrated by the active bed(s) by adjusting the operating conditions (frequency f) of the magnetic field modulation device 40 and the heat transport device 50. Furthermore, the control device 25 has a function of operating the MHP device 20 under a combination of the active bed number N and the operating condition based on the preset map. The combination satisfies the required capacity and provides high efficiency.

The combination of the operating conditions and the active bed number N to be selected according to the required capacity can be preset as a performance map. As a result, it is possible to meet the required capacity, and to select the operating condition and the active bed number N with a good efficiency COP. The performance map is preset so as to determine an efficient combination from a plurality of combinations of the active bed number N that satisfy the required capacity and the operating conditions.

In step 174, a radial positioning of the active bed(s) is determined. Here, the arrangement of the active bed is determined so as to suppress the torque fluctuation in the rotary shaft 41. That is, due to the magnetic force acting between the element bed 30 and the magnetic field modulation device 40, torque fluctuation appears on the rotary shaft 41. By properly setting a radial positioning of the active bed and the inactive bed in the circumferential direction, torque fluctuations are suppressed. The controller 25 controls the magnetic field modulation device 40, the heat transport device 50, and the variable flow path mechanism 60 in order to arrange the active bed(s) so as to suppress the torque fluctuation.

FIG. 7 shows the arrangement of the element bed 30 in the case of 12 beds. Consider a case where two beds are activated. When the first and seventh beds are operated, the two-pole permanent magnet 42 simultaneously faces the active beds. In this case, the rotary shaft 41 receives magnetic force simultaneously acting between the two-pole permanent magnet 42 and the two active beds. In particular, excessive torque is generated when the active beds gets out of the magnetic field. For this reason, a large torque fluctuation appears on the rotary shaft 41.

Contrary, if the first bed and the fourth bed are activated, the two-pole permanent magnets 42 sequentially face the active beds. In this case, magnetic force acting between the two-pole permanent magnet 42 and the two beds acts on the rotary shaft 41 in an order. In this case, since only one of the active beds is located in the magnetic field, the magnetic forces cancel each other. The suppressed torque fluctuation appears on the rotary shaft 41.

The magnetic field modulation device 40 often arranges the plurality of permanent magnets 42 at equal intervals for weight balance. The plurality of permanent magnets 42 are arranged symmetrically. When activating a plurality of beds, it is desirable that the plurality of active beds be arranged at irregular intervals. The plurality of active element beds 30 are arranged asymmetrically in the circumferential direction. By arranging the active element beds 30 asymmetrically while the plurality of permanent magnets 42 are symmetrical, torque fluctuation is suppressed.

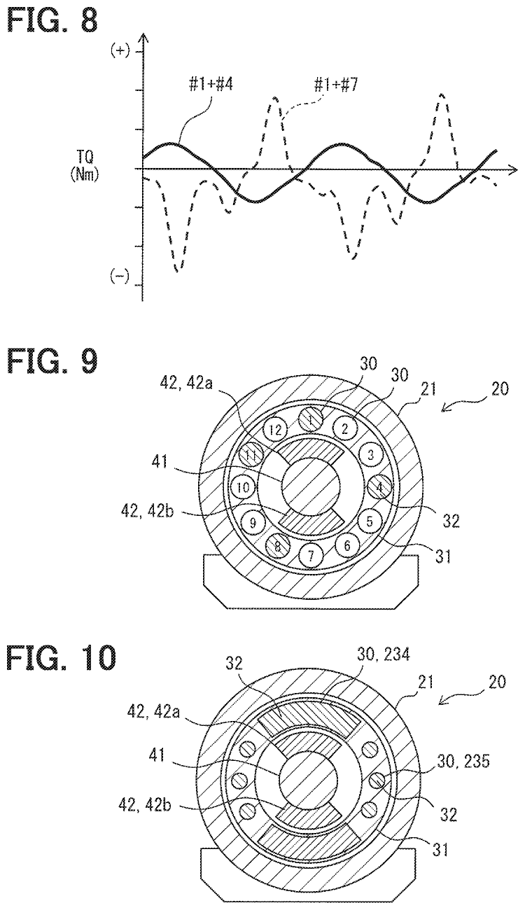

FIG. 8 shows torque fluctuation. The vertical axis represents torque TQ (Nm). The horizontal axis indicates the rotation of the rotary shaft 41, i.e., time. When the first bed and the seventh bed are activated, as indicated by the broken line waveform #1+#7, large torque fluctuations which have peaks at every π/2(pi/2) appear. On the other hand, when the first and fourth beds are activated, as indicated by the solid line waveform #1+#4, small torque fluctuations which have peaks at every π/2(pi/2) appear.

FIG. 9 shows the arrangement of the element beds 30 in the case of 12 beds. Consider cases where four beds are in active. When the active beds are arranged at equal intervals, for example, the first, the fourth, the seventh and the tenth are activated. On the other hand, when the active beds are arranged at irregular intervals, for example, the first, fourth, eighth and eleventh are activated.

Returning to FIG. 3, in step 175, the variable flow path mechanism 60 is controlled so as to realize the active bed number obtained in step 173 in the arrangement determined in step 174. Specifically, control is performed to open the on-off valve 61 of the active bed and to close the on-off valve 61 of the inactive bed. Thereby, the variable flow path mechanism 60 operates a part of the plurality of element beds 30 as the active bed(s) and causes a part to be suspended as the inactive bed(s). In step 176, the MHP device 20 is operated.

In the control method of the thermomagnetic cycle device, the control device 25 controls the variable flow path mechanism 60 so as to suppress power consumption (so that the efficiency COP becomes high) while realizing the required thermal capacity. Furthermore, the controller 25 adjusts the operating condition of the magnetic field modulator 40 and the heat transport device 50, that is, the frequency f, in order to adjust the capacity of the plurality of element beds 30. In a typical example, the variable flow path mechanism 60 changes the active bed number and the inactive bed number in the plurality of element beds 30. Furthermore, the active bed(s) is arranged in the plurality of element beds 30 so as to suppress torque fluctuations. The magnetic field modulation device 40 includes a plurality of permanent magnets 42 disposed symmetrically along the circumferential direction. In this case, the variable flow path mechanism 60 asymmetrically arranges the active bed(s) among the plurality of element beds 30 along the circumferential direction so as to suppress the torque fluctuation.

The device described above changes the structure of the flow path of the element bed 30 filled with the MCE element 32 so as to realize the required capacity. Moreover, the structure of the flow path is varied to minimize the power consumed. The power consumption may include a magnetic field fluctuation work and a pump work. As a result, control is performed to increase efficiency while satisfying the required capacity. A variable flow path mechanism 60 is provided to change the flow path 32a provided by the plurality of element beds 30. The flow path 32a is controlled to suppress power consumption while realizing the required capacity. Thus, when there are a plurality of flow path options which can realize the required capacity, a flow path that suppresses power consumption is selected. Thereby, it is possible to provide the thermomagnetic cycle device which suppresses power consumption while satisfying the required capacity.

In another aspect, the variable flow path mechanism 60 activates a part of the plurality of element beds 30 and deactivates a part of them to rest. Thereby, it is possible to adjust the capacity. In a typical example, the required capacity is satisfied by adjusting the number of flow path used, e.g., the active bed number. The number of flow path used is set such that the circumferential position of the active bed(s) 30 can suppress the cogging torque. In the preferred example, the torque curves caused by the plurality of active bed(s) 30 cancel each other.

The structure of the flow path can be changed by an electronically controlled valve or actuator. Also, when multiple sets of reciprocating pumps are used, each set can be activated or deactivated independently. Thereby, in addition to changing the active bed number, the circumferential position of the active bed(s) can be changed. Furthermore, the capacity of the plurality of element beds 30, the cascade arrangement, may be a plurality of different capacities or a plurality of different cascade arrangements. For example, the MCE elements 32 in a cascade arrangement for activation may be disposed in a predetermined element bed 30, and the element bed 30 may be activated at the time of activation.

According to the embodiment described above, the operating conditions and the active bed number are set so as to satisfy the required performance. Furthermore, a combination of efficient operating conditions and the number of active bed(s) can be set. Furthermore, the active bed(s) are arranged at irregular intervals. Thereby, the torque fluctuation in the rotating shaft 41 is suppressed.

### Second Embodiment

This embodiment is a modification in which the preceding embodiment is a fundamental form. In the above embodiment, the plurality of element beds 30 are all the same size. Alternatively, the plurality of element beds 30 may have different sizes.

In FIG. 10, the container 31 includes a plurality of element beds 30. The plurality of element beds 30 include a first element bed 234 and a second element bed 235. The first element bed 234 has a larger capacity than the second element bed 235. The first element bed 234 has a fan-shaped cross section. The second element bed 235 has a circular cross section. The first element bed 234 and the second element bed 235 are circumferentially separated from each other.

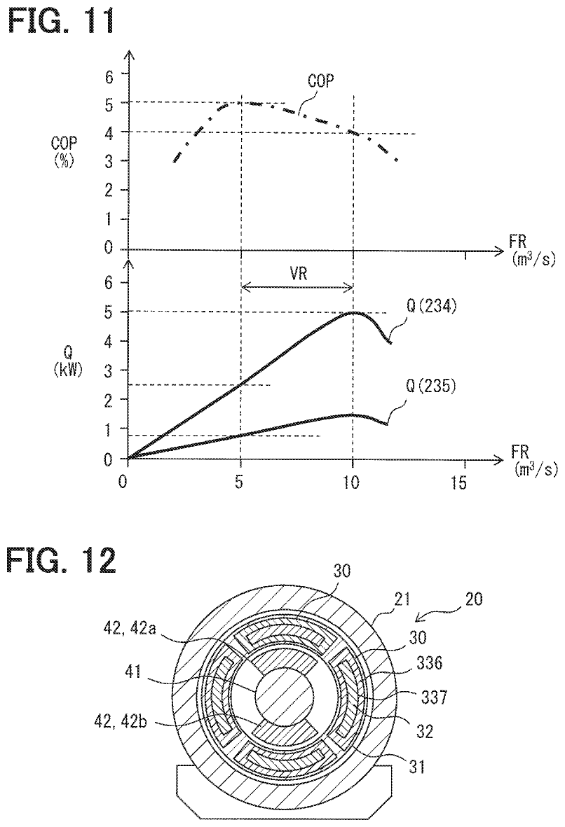

FIG. 11 shows the performance curve Q (234) of the first element bed 234 and the performance curve Q (235) of the second element bed 235. The first element bed 234 and the second element bed 235 use the same MCE element 32. Thus, the first element bed 234 and the second element bed 235 have a common efficiency curve COP. The maximum capacity that the first element bed 234 can demonstrate is greater than the maximum capacity that the second element bed 235 can demonstrate. The first element bed 234 can demonstrate the maximum capacity of about 5.0. The second element bed 235 can demonstrate the maximum capacity of about 1.5.

When the maximum capacity is required, the MHP device 20 may be operated under the operating condition FR=10, as a result, the MHP device 20 can demonstrate the capacity Q=5.0×2+1.5×6=19 and can realize the efficiency of about COP=4.

When a partial capacity is required, the MHP device 20 may be operated under the operating condition FR=5, as a result, the MHP device 20 can demonstrate the capacity Q=2.5×2+0.8×6=9.8 and can realize the efficiency of about COP=5. By activating only one first element bed 234 under the minimum operating condition FR=5, the capacity Q=2.5×1=2.5 can be demonstrated, and the efficiency about COP=5 is realized. Similarly, by activating only one second element bed 235 under the minimum operating condition FR=5, the capacity Q=0.8×1=0.8 can be demonstrated, and the efficiency about COP=5 is realized. According to this embodiment, in addition to the advantages of the preceding embodiments, the provision of a plurality of element beds 234, 235 with different capacities enables high efficiency operation. As described above, by selectively using the plurality of element beds 234 and 235 having different capacities, operation near the highest efficiency COP becomes possible.

### Third Embodiment

This embodiment is a modification in which the preceding embodiment is a fundamental form. In the above embodiment, one element bed 30 is controlled to be activated or deactivated. Alternatively, an effective passage cross-sectional area (effective element volume) may be changed in one element bed 30.

In FIG. 12, the MHP device 20 has a plurality of element beds 30 arranged in the circumferential direction. One element bed 30 has a first partial bed 336 and a second partial bed 337. The first partial bed 336 and the second partial bed 337 occupy the same range in the circumferential direction. The first partial bed 336 and the second partial bed 337 overlap each other in the radial direction. The first partial bed 336 and the second partial bed 337 are disposed in multi-layered manner in one element bed 30. The first partial bed 336 is disposed on an outside of the second partial bed 337. The second partial bed 337 is disposed within the first partial bed 336.

In this embodiment, it is possible to adjust the element volume included in one element bed 30, In addition, a plurality of element beds 30 are operated as the active bed and the inactive bed. The first partial bed 336 provides a first partial volume, e.g., 0.6. The second partial bed 337 provides a second partial volume, e.g., 0.4. Both the first partial bed 336 and the second partial bed 337 provide an overall volume, e.g., 1.0.

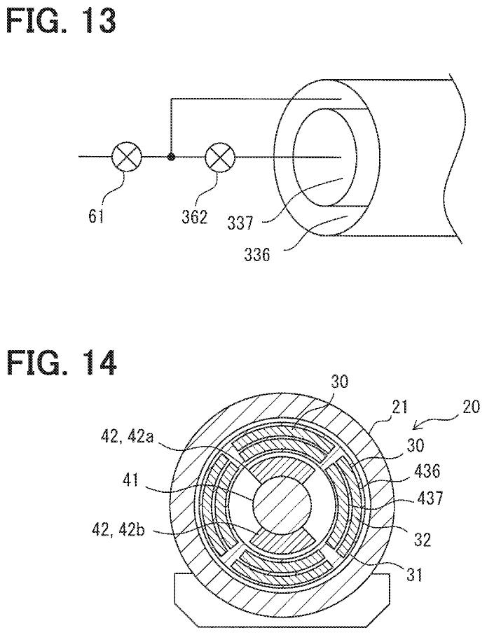

FIG. 13 shows a flow path when partial beds 336 and 337 are modeled as cylinders. In the flow path common to the plurality of partial beds 336 and 337, an on-off valve 61 for switching between the active bed and the inactive bed is disposed. In the flow path of only one partial bed 336, an on-off valve 362 for switching the element volume is disposed. The on-off valve 362 may be provided also in the flow path of the partial bed 336 alone.

In the control method of the MHP device 20, the on-off valves 61, 362 are controlled to provide the volume of the MCE element 32 necessary to satisfy the required capacity. If only the first partial bed 336 in one element bed 30 is activated, a minimum element volume of 0.6×1=0.6 is provided. If only one element bed 30 is activated, an element volume of 1.0×1=1.0 is provided.

This embodiment may include only the on-off valve 362 without providing the on-off valve 61. Also in this case, the element volume of the active bed(s) in the MHP device 20 can be adjusted. Furthermore, it is possible to meet the required capacity by adjusting the flow rate FR as the operating condition. Even when only the on-off valve 362 is provided, the variable flow path mechanism 60 is provided that changes the structure of the flow path 32a in the plurality of element beds 30.

According to this embodiment, the structure of the flow path of the element bed 30 filled with the MCE element 32 is changed so as to realize the required capacity. Moreover, the structure of the flow path is varied to minimize the power consumed. The power consumption may include a magnetic field fluctuation work and a pump work. As a result, control is performed to increase efficiency while satisfying the required capacity.

### Fourth Embodiment

This embodiment is a modification in which the preceding embodiment is a fundamental form. In the above embodiment, the partial beds 336, 337 are arranged in a multi-layered manner. Alternatively, the plurality of partial beds can be arranged in various ways. In this embodiment, partial beds 436, 437 located on an inner position and an outer position in a radial direction in the MHP device 20 are employed.

In FIG. 14, the first partial bed 436 and the second partial bed 437 are disposed radially inward and outward in the MHP device 20. The first partial bed 436 is disposed outside of the second partial bed 437 with respect to the radial direction of the MHP device 20. The second partial bed 437 is disposed inside of the first partial bed 436 with respect to the radial direction of the MHP device 20. Also in this embodiment, the same effects as those of the preceding embodiments can be obtained.

### Fifth Embodiment

This embodiment is a modification in which the preceding embodiment is a fundamental form. In the above embodiment, the pumps 51, 52 are reciprocating displacement pumps. Alternatively, the pumps 51, 52 can be provided by one-way pumps. In this case, the end of the element bed 30 is alternately communicated with the suction side and the discharge side of the pump to provide a reciprocating flow. The reciprocating flow can be provided by the variable flow path mechanism 60.

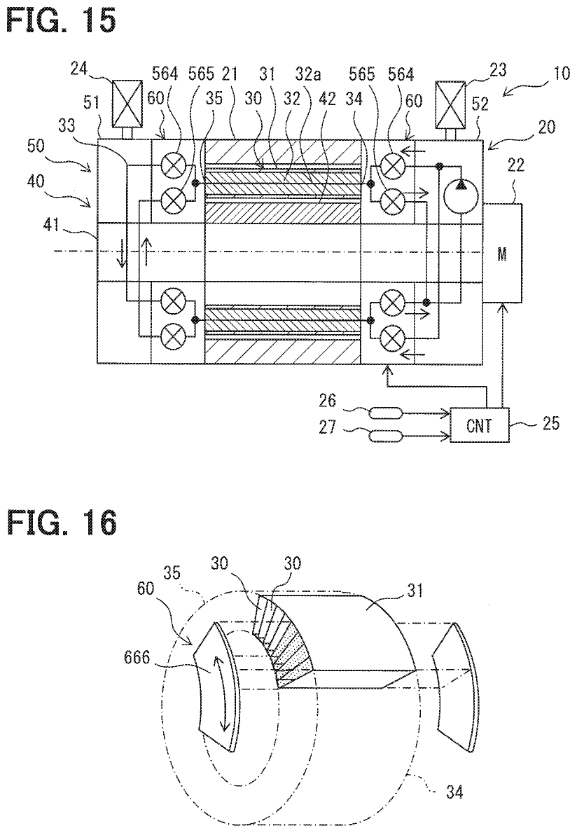

In FIG. 15, the variable flow path mechanism 60 has on-off valves 564 and 564 and on-off valves 565 and 565 for one element bed 30. The on-off valve 564 provides a flow from the cold end 34 to the hot end 35. The on-off valve 565 provides a flow from the hot end 35 to the cold end 34. The on-off valve 564 at the right end is disposed between the element bed 30 and the discharge side of the pump. The on-off valve 565 at the right end is disposed between the element bed 30 and the suction side of the pump. In this embodiment, the left end pump 51 is provided only by the communication passage. The pump 51 may include a pump.

The plurality of on-off valves 564 and 565 are controlled to open and close to provide a reciprocating flow, and are controlled to open and close to provide the active bed and the inactive bed. Also in this embodiment, the same effects as those of the preceding embodiments can be obtained.

### Sixth Embodiment

This embodiment is a modification in which the preceding embodiment is a fundamental form. In the above embodiment, the variable flow path mechanism 60 is provided by the on-off valves. Alternatively, the variable flow path mechanism 60 may change the flow path in the element bed by a shutter-type valve.

FIG. 16 is a perspective view showing the element bed 30 and the variable flow path mechanism 60. The container 31 has a plurality of element beds 30. One element bed 30 extends from the cold end 34 to the hot end 35. The plurality of element beds 30 are parallel each other. The plurality of element beds 30 open at both the cold end 34 and the hot end 35. The plurality of element beds 30 are arranged in the circumferential direction.

The variable flow path mechanism 60 has a shutter valve 666. The shutter valve 666 is movable in the circumferential direction. The shutter valve 666 opens and closes the plurality of element beds 30. In the illustrated example, about half (shaded area) of the plurality of element beds 30 illustrated is closed. The closed element beds 30 provide the deactivated beds. The remaining open element bed(s) 30 provides the active bed(s).

The shutter valve 666 makes it possible to open and close a plurality of element beds 30 with one actuator. The shutter valve 666 is also equivalent to multiple on-off valves. Also in this embodiment, the same effects as those of the preceding embodiments can be obtained.

### Other Embodiments

The disclosure in this specification, the drawings, and the like is not limited to the illustrated embodiments. The disclosure encompasses the illustrated embodiments and variations thereof by those skilled in the art. For example, the disclosure is not limited to the parts and/or combinations of elements shown in the embodiments. The disclosure can be implemented in various combinations. The disclosure may have additional parts that may be added to the embodiment. The disclosure encompasses omissions of parts and/or elements of the embodiments. The disclosure encompasses replacement or combination of parts and/or elements between one embodiment and another. The disclosed technical scope is not limited to the description of the embodiment. Several technical scopes disclosed are indicated by descriptions in the claims and should be understood to include all modifications within the meaning and scope equivalent of the descriptions in the claims.

The disclosure in the specification, drawings and the like is not limited by the description of the claims. The disclosures in the specification, the drawings, and the like encompass the technical ideas described in the claims, and further extend to a wider variety of technical ideas than those in the claims. Therefore, various technical ideas can be extracted from the disclosure of the specification, the drawings and the like without being limited to the description of the claims.

In the above embodiment, by controlling the flow of the heat transport medium 33, the active element bed 30 and the inactive element bed 30 are switched. Flow control may be realized by interrupting the flow by means of a valve, or interrupting the operation of the pump itself. Alternatively, by controlling the magnetic field applied to the element bed 30, the element bed 30 may be switched between the active bed and the inactive bed. For example, the waveform (profile) of the magnetic field can be controlled. For example, the position of a member shielding the magnetic flux linked to the element bed 30 can be controlled.

Further, in the above embodiment, the MCE elements 32 in all the element beds 30 are connected in the same cascade connection. Alternatively, each of the plurality of element beds 30 may have different cascade connections. For example, the number of stages of cascade connection of one element bed 30 and the number of stages of cascade connection of another one element bed 30 may be different. The number of stages of cascade connection may be selected according to the required capacity or according to the frequency.

What is claimed is:

1. A thermomagnetic cycle device, comprising:
a plurality of element beds providing a magneto-caloric effect element demonstrating a magneto-caloric effect, and a flow path which allow a flow of a heat transport medium to perform heat-exchange with the magneto-caloric effect element;
a variable flow passage mechanism which changes a structure of the flow path in the plurality of element beds; and
a controller which controls the variable flow path mechanism so as to suppress power consumption while achieving a required capacity.

2. The thermomagnetic cycle device claimed in claim 1, further comprising:
a magnetic field modulation device which modulates a magnetic field applied to the magneto-caloric effect element; and
a heat transport device which generates a reciprocating flow of the heat transport medium which performs heat-exchange with the magneto-caloric effect element, and wherein
the control device adjusts operating conditions of the magnetic field modulation device and the heat transport device in order to adjust a capacity demonstrated by the plurality of element beds.

3. The thermomagnetic cycle device claimed in claim 2, wherein
the operating condition is a frequency of the magnetic field modulation device and the heat transport device.

4. The thermomagnetic cycle device claimed in claim 1, wherein
the variable flow path mechanism changes a number of at least one active bed and a number of at least one inactive bed in the plurality of element beds.

5. The thermomagnetic cycle device claimed in claim 4, wherein
the active bed is arranged to suppress torque fluctuation in the plurality of element beds.

6. A thermomagnetic cycle device, comprising:
a plurality of element beds including a magneto-caloric effect element demonstrating a magneto-caloric effect;
a magnetic field modulation device which modulates the magnetic field applied to the magneto-caloric effect element;
a heat transport device which generates a reciprocating flow of a heat transport medium which performs heat-exchange with the magneto-caloric effect element; and
a variable flow path mechanism which activates a part of the plurality of element beds as at least one active bed and deactivates a part of the plurality of element beds as at least one inactive bed.

7. The thermomagnetic cycle device claimed in claim 6, wherein
the variable flow path mechanism includes a valve that controls the flow of the heat transport medium in the plurality of element beds.

8. The thermomagnetic cycle device claimed in claim 6, wherein
the magnetic field modulation device comprises a plurality of permanent magnets arranged symmetrically along the circumferential direction, and wherein
the variable flow path mechanism arranges the active bed in the plurality of element beds asymmetrically along a circumferential direction to suppress a torque fluctuation.

9. The thermomagnetic cycle device claimed in claim 6, further comprising:
a control device which controls a number of the active bed by the variable flow path mechanism, and controls a thermal capacity demonstrated by the active bed by adjusting operating conditions of the magnetic field modulation device and the heat transport device, wherein
the control device performs, based on a predetermined map, a combination of the number of the active bed and the operating condition, the active bed and the operating condition being satisfy both the required capacity and realizing high efficiency.

10. The thermomagnetic cycle device claimed in claim 9, wherein
the map is predetermined so as to determine an efficient combination from a plurality of combinations of the number of the activated bed and the operating conditions, the combinations being satisfy the required capacity.
